(19) United States
(12) Patent Application Publication
(10) Pub. No.: US 2009/0112681 A1
(43) Pub. Date: Apr. 30, 2009

(54) Method and system for click-to-call

(75) Inventors: Srinivasan Krishnan, Palo Alto, CA (US); Thomas Cochrane, San Francisco, CA (US); Scott Osler, Mountain View, CA (US); Vinayak Saokar, Fremont, CA (US); Shankar Srinivasan, Saratoga, CA (US)

Correspondence Address: William L. Botjer, PO Box 478, Center Moriches, NY, 11934, US

(73) Assignee: Vimo Inc.

(21) Appl. No.: 11/977,888

(22) Filed: Oct. 26, 2007

(51) Int. Cl. G06Q 10/00; G06F 17/30; G06F 17/40

(52) U.S. Cl. 705/9

(57) ABSTRACT

A method and system for establishing a connection between a sales agent and a user. A telephone connection is established by a lead generator. The sales agent is selected by the lead generator on the basis of a bid price method and is connected to the user on the basis of the user's services of interest. A unique billing system is also provided for billing the sales agent. The invention may be implemented on a stored program computer under the control of programmed software.

### BACKGROUND

The present invention relates to establishing a connection in general. More specifically, the present invention relates to a method and system for establishing a connection between a user and a sales agent.

Today, the Internet is used as a medium for conducting commercial activities such as online transactions and the sale of products and services. Examples of websites on the Internet that are used for the sale of products and services include Yahoo®, Amazon®, and the like. Examples of services offered over the Internet include insurance services, booking of tickets, and the like.

Over the years, websites that handle online sales have become increasingly efficient and easy to use. However, frequently online sales are not completed or are abandoned midway because the user either does not have enough information or is confused by too much information. At such times, it is necessary to add the human touch, wherein a salesperson can talk to users and suggest the product or service that would suit them the best. This approach is especially important for the online sale of services such as insurance plans.

Online sales are primarily dependent on the interaction between users and the website. During an online sale, users may often call a toll-free number or a call center to explain their needs and preferences. Such calls may then be transferred to the appropriate person, where they would be required to repeat their needs and preferences. Further, when a user initiates a call, the person who responds to it first is generally not a salesperson. Consequently, this person is not able to help the user by answering questions and providing the information required. This results in the customer losing interest in the online sale and consequently being dissatisfied.

Similarly, salespersons often receive calls from users, whom they cannot service. Call centers often connect users to salespersons whose service they are not interested in. For example, a call center may connect a user to a health insurance salesperson when the user is interested in auto insurance. A salesperson may also receive calls from users about services, which can easily be serviced through self-help services or the website. Such calls are unproductive and result in loss of time and efficiency. As a result, salespersons' billing may become skewed and they may have to end up paying for calls that have not resulted in any business transaction being concluded.

Hence, there is a need for a method for establishing a connection between a user and a salesperson, wherein the user is connected directly to the salesperson providing a service the user is interested in. There is also the need to add a human touch to online sales, reduce the number of false calls received by a salesperson, and improve the billing system for leads generated. Such a method would improve users' satisfaction and the productivity of salespersons.

### SUMMARY

An object of the present invention is to provide a method and system for establishing a telephone connection between a sales agent and a user.

Another object of the present invention is to provide a method and system for directing a sales lead to a selected sales agent, the selected sales agent being selected on the basis of a bid price method.

Another object of the present invention is to provide a method and system for the billing of the sales agent connected to the user.

To achieve the foregoing objectives, the present invention describes a method and system for establishing a connection between the user and the sales agent by a lead generator comprising a database of one or more sales agents. These one or more sales agents register with the lead generator. The registration comprises providing an exclusive lead price, a shared lead price and a first phone number corresponding to each of the one or more sales agents. When the user enters the second phone number on the one or more websites present on an Internet form, the lead generator selects at least one of the one or more sales agents, based on an exclusive lead value index and a shared lead value index. The exclusive lead value index is based on the exclusive lead price and the shared lead value index on the shared lead price. Thereafter, the at least one selected sales agent is connected to the user and a connection is established between the first and second phone numbers.

The present invention provides a method and system for establishing a connection between the user and the sales agent based on the services-of-interest of the user. This helps in reducing the number of false calls that a sales agent and a user have to go through using the existing systems. Further, as the system connects the user with the sales agent based on the services-of-interest, the chances of successful conversion of a lead also increases. Furthermore, the method is automated and does not require manual intervention to establish the connection. The invention also provides a simplified billing system for sales agents.

### BRIEF DESCRIPTION OF THE DRAWINGS

The preferred embodiments of the invention will hereinafter be described in conjunction with the appended drawings, provided to illustrate and not to limit the invention, wherein like designations denote like elements, and in which:

FIG. 1 illustrates an environment in which various embodiments of the present invention may be practiced.

FIG.2 illustrates the connection between a lead generator and a connecting module, in accordance with an embodiment of the present invention.

FIG. 3 illustrates various components of the selecting module, in accordance with an embodiment of the present invention.

FIG. 4 is a flowchart for connecting the user with the sales agent, in accordance with an embodiment of the present invention.

FIG. 5 is a flowchart for connecting the user with the sales agent, in accordance with another embodiment of the present invention.

FIG.6 is a flowchart illustrating a bid price method for selecting at least one of the one or more sales agents who can be connected to the user, in accordance with an embodiment of the present invention.

FIG. 7 is a flowchart for the calculation of the first shared lead price index, according to one of the embodiments of the present invention.

### DESCRIPTION OF THE PREFERED EMBODIMENTS

The present invention illustrates a method and system for connecting a user with a sales agent. Specifically, the invention aims at connecting the user with the sales agent by a lead generator. This lead generator includes a database of one or more sales agents, and the connection is established between a first phone number and a second phone number.

The invention includes registering the one or more sales agents with the lead generator. The registration of the one or more sales agents includes providing the first phone number, an exclusive lead price and a shared lead price. The user enters the second phone number on an Internet form on one or more websites. The Internet form is maintained by the lead generator. On the user entering the second phone number, the lead generator selects at least one of the one or more sales agents, on the basis of an exclusive lead value index and a shared lead value index. The exclusive lead value index is based on the exclusive lead price, and the shared lead value index on the shared lead price. After the selection of the at least one sales agent, a connection is established between the selected at least one sales agent and the user.

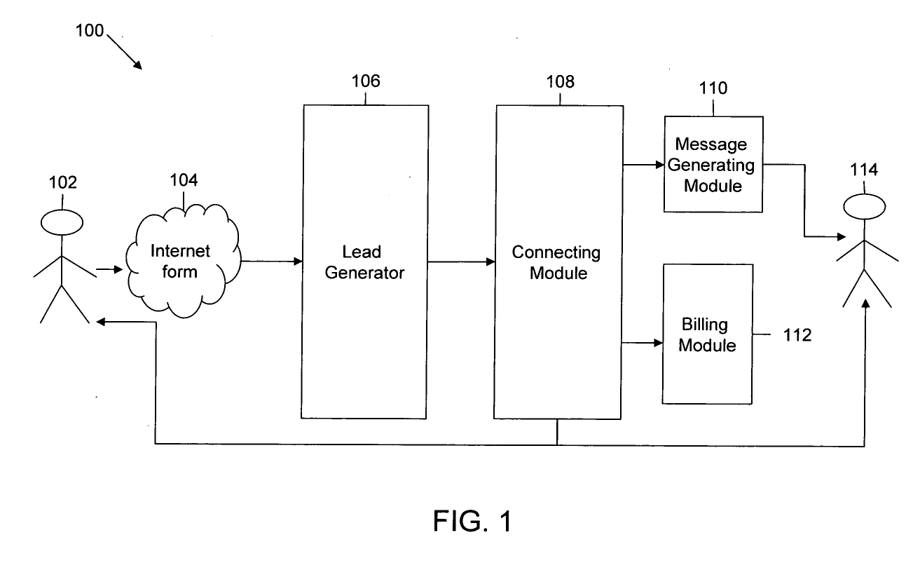

FIG. 1 illustrates an environment 100 in which various embodiments of the present invention may be practiced. Environment 100 includes a user 102, an Internet form 104, a lead generator 106, a connecting module 108, a message generating module 110, a billing module 112, and a sales agent 114. In various embodiments of the present invention, environment 100 includes one or more sales agents.

User 102 enters a second phone number on one or more websites on Internet form 104. The second phone number corresponds to user 102. Internet form 104 is maintained by lead generator 106, which includes a record and a first phone number corresponding to each of the one or more sales agents. When the user enters the second phone number on the one or more websites on Internet form 104, lead generator 106 selects at least one of the one or more sales agents. Thereafter, connecting module 108 establishes a connection between user 102 and sales agent 114 from the selected at least one sales agent. Subsequently, in various embodiments of the present invention, message generating module 110 sends an introductory message to sales agent 114 which includes information pertaining to user 102.

According to an embodiment of the present invention, the introductory message may be a voice message, which may be voice-transcription information, based on one or more services-of-interest to user 102. The voice message may include information on the demographic profile of user 102, a sponsored message from a product provider, and the like. The product provider provides the voice message, based on the one or more services of interest to user 102.

According to an embodiment of the present invention, the introductory message may be transmitted through an electronic channel. Examples of electronic channels include and are not limited to Short Messaging Service (SMS), email, and the like.

According to another embodiment of the present invention, the introductory message may be transmitted in parallel when the connection between user 102 and sales agent 114 is established.

Subsequently, billing module 112 bills sales agent 114 when a connection is established between user 104 and sales agent 114. The billing of sales agent 114 is based on various factors. Examples of these factors, which affect billing, include the length of the call, the demographic profile of user 102, the geographic location of user 102, the one or more services of interest of user 102, and the frequency and volume of usage of lead generator 106 by sales agent 114.

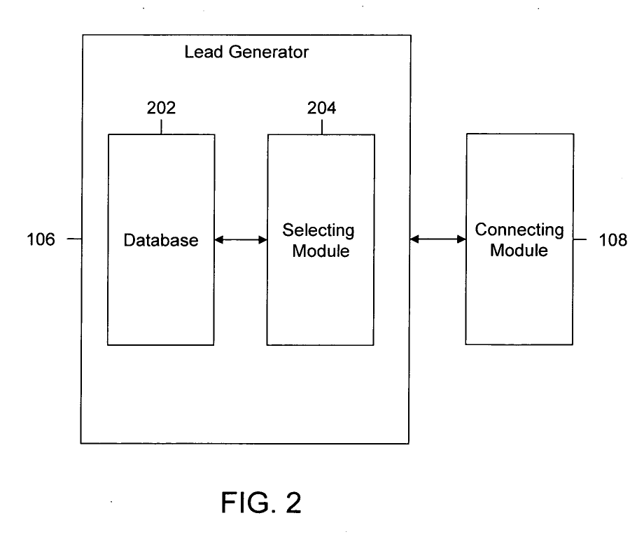

FIG. 2 illustrates the connection between lead generator 106 and connecting module 108, in accordance with an embodiment of the present invention. Lead generator 106 includes a database 202 and a selecting module 204. Database 202 includes records corresponding to each of the one or more sales agents, such as sales agent 114. The one or more sales agents register with database 202. The registration process of each of the one or more sales agents includes providing the first phone number, an exclusive lead price and a shared lead price.

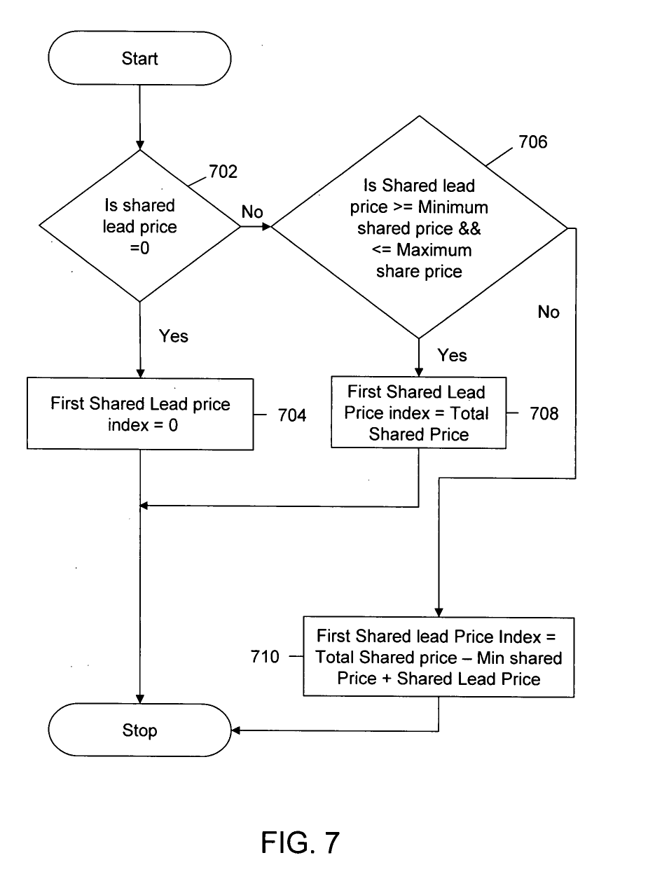

The exclusive lead price is a bid price provided by the one or more sales agents for an exclusive assignment of a lead. The shared lead price is a bid price provided by the one or more sales agents for the shared assignment of the lead. Further, database 202 includes records of a first shared lead price index, a manual rating, a lead return rate, and a lead price weight corresponding to each of the one or more sales agents. The first shared lead price index is described in detail in conjunction with FIG. 7. The manual rating is assigned to each of the one or more sales agents, based on a request made by the one or more sales agents for a lower or higher percentage of lead flow. In various embodiments of the present invention, a manual rating of 0.8 is the default rating assigned to each of the one or more sales agents. However, if a sales agent makes a request for a higher percentage of the lead flow, the manual rating for the corresponding sales agent may be changed to 1. The manual rating may also be set as 0 for a sales agent who makes a request for a lower percentage of lead flow. In various embodiments of the invention, the lead price weight is equal to ten. However, in other embodiments the lead price weight may be change to other values

The lead return rate is the ratio between the lead flow that has been returned, or has been unsuccessful, to the total number of lead flow received, corresponding to each of the one or more sales agents. The lead return rate can be defined by equation 1:

Lead return rate=(number of unsuccessful leads)/(total number of lead flow) (1)

Furthermore, database 202 includes records of a minimum shared price, a maximum shared price and a total shared price corresponding to the one or more sales agents. The minimum shared price is the minimum value of the shared lead prices corresponding to the one or more sales agents. The maximum shared price is the maximum value of the shared lead prices corresponding to the one or more sales agents. The total shared lead price is the sum of all the shared lead prices corresponding to the one or more sales agents.

Selecting module 204 selects at least one of the one or more sales agents. To make the selection, selecting module 204 calculates a second shared lead price index, an exclusive lead price index, a broker rating index, a shared lead value index, and an exclusive lead value index. The second shared lead price index is based on the first shared lead price index and the lead price weight is defined by equation 2:

Second shared lead price index=(first shared lead price index)*(lead price weight) (2)

The exclusive lead price index is based on the exclusive lead price and the lead price weight and is defined by equation 3:

Exclusive lead price index=(exclusive lead price)*(lead price weight) (3)

The broker rating index is based on the manual rating and the lead return rate is defined by equation 4:

Broker rating index=(manual rating)*(10)*(1*(1−(lead return rate)/100)) (4)

The shared lead value index is based on the second shared lead price index and the broker rating index is defined by equation 5:

Shared lead value index=(second shared lead price index)+(broker rating index) (5)

The exclusive lead value index is based on the exclusive lead price and the broker rating index is defined by equation 6:

Exclusive lead value index=(exclusive lead price index)+(broker rating index) (6)

Subsequently, selecting module 204 selects at least one of the one or more sales agents, based on the shared lead value index and the exclusive lead value index. Thereafter, the selected sales agent, such as sales agent 114 in FIG. 1, is connected to user 102 by connecting module 108, wherein connecting module 108 establishes the connection between the first phone number and the second phone number.

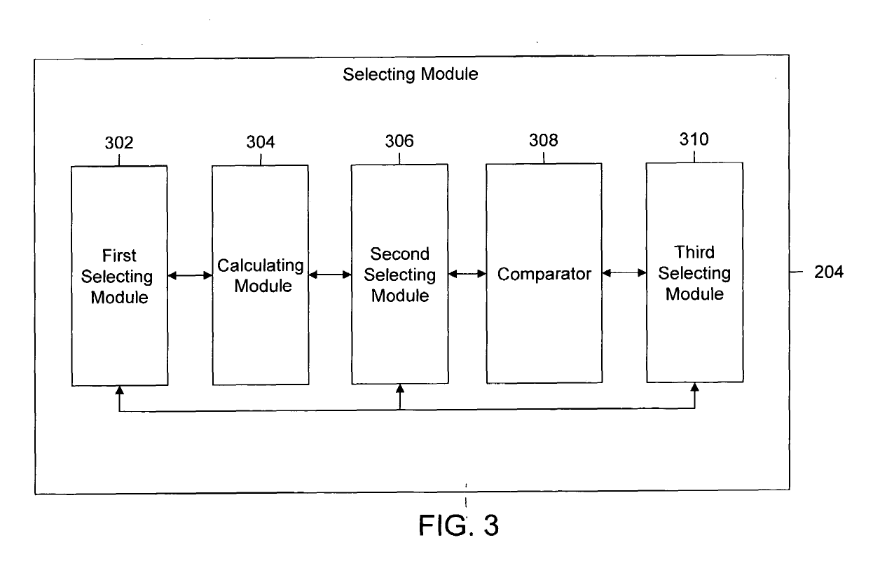

FIG. 3 illustrates various components of selecting module 204, in accordance with an embodiment of the present invention. Selecting module 204 includes a first selecting module 302, a calculating module 304, a second selecting module 306, a comparator 308, and a third selecting module 310. First selecting module 302 selects a first set of the one or more sales agents. The first set of sales agents is selected from the one or more sales agents on the basis of the shared lead price. The first set of sales agents includes sales agents with higher shared lead prices among the one or more sales agents.

Subsequently, calculating module 304 calculates the shared lead value index, the exclusive lead value index, the second shared lead price index, the exclusive lead price index and the broker rating index of the first set of sales agents. Subsequently, second selecting module 306 selects the highest exclusive lead value index and the highest shared lead value index that correspond to the first set of sales agents. Thereafter, comparator 308 compares the highest exclusive lead value index and the highest shared lead value index of each of the first set of sales agents. In an embodiment of the present invention, if the highest exclusive lead value index is greater than the highest shared lead value index, third selecting module 310 selects one sales agent with the highest exclusive lead value index from the one or more sales agents. In accordance with another embodiment of the invention, if there is more than one sales agent with the same highest exclusive lead value index, the lead is directed randomly to one of these sales agents.

In an embodiment of the present invention, third selecting module 310 selects a second set of one or more sales agents from the first set of sales agents if the highest exclusive lead value index is less than the highest shared lead value index. The sales agent from the second set of sales agents, who responds to the call first is connected to user 102.

In accordance with another embodiment of the invention, the second set of sales agents includes the sales agents from the first set of sales agents, who have been selected on the basis of their pre-defined threshold lead return rate. The pre-defined threshold lead return rate, which corresponds to the lowest and highest lead return rates, is entered in database 202.

In accordance with yet another embodiment of the invention, the second set of sales agents is equal to the first set of sales agents when each of the sales agents of the first set of sales agents has a lead return rate that is below the pre-defined threshold lead return rate.

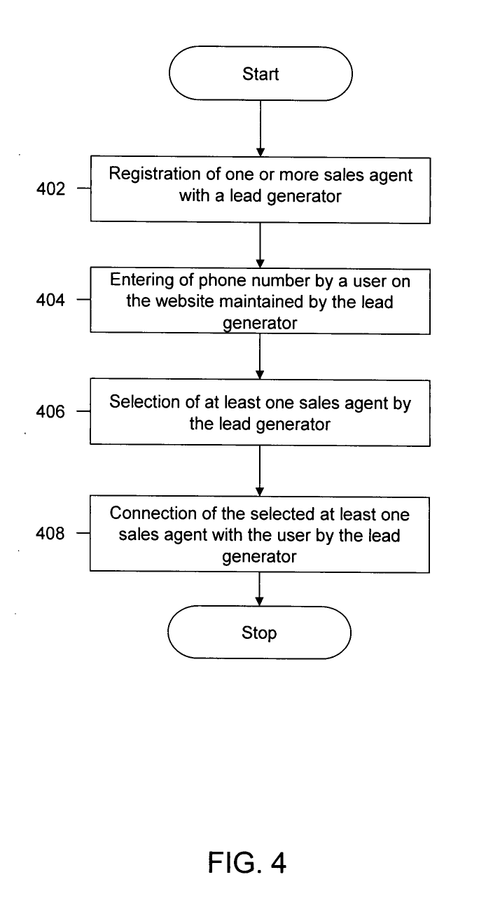

FIG. 4 is a flowchart for connecting user 102 with sales agent 114, in accordance with an embodiment of the present invention. At step 402, the one or more sales agents register with lead generator 106. The registration of the one or more sales agents includes providing the first phone number, the exclusive lead price and the shared lead price corresponding to each of the one or more sales agents. The first phone number corresponds to the one or more sales agents. The exclusive lead price is the bid price provided by the sales agents for the exclusive assignment of a lead. The shared lead price is the bid price provided by the sales agents for a shared assignment of the lead. This shared assignment of the lead refers to a situation when the lead is directed to a plurality of sales agents, and the user is connected to the sales agent who responds to the call first.

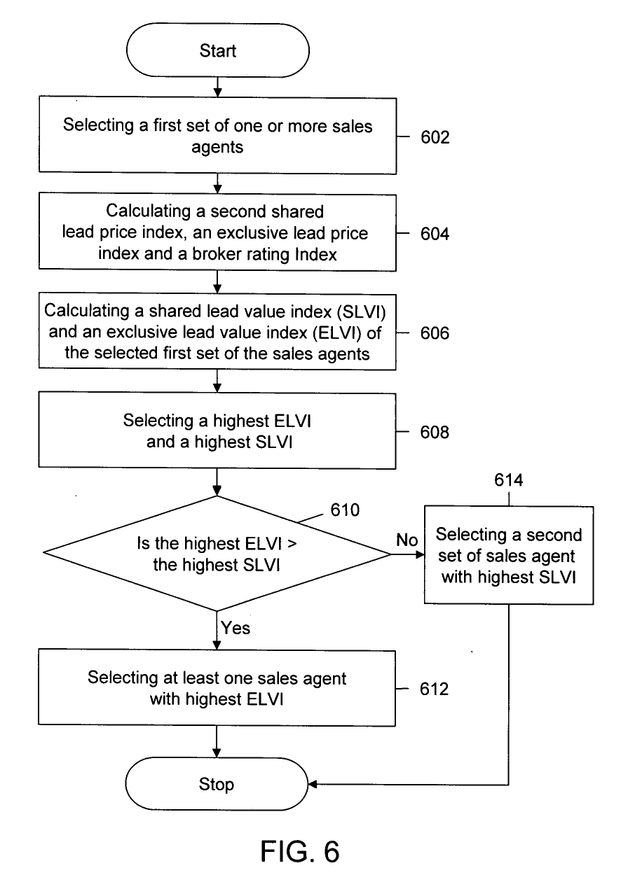

At step.404, user 102 enters the second phone number on one or more websites. The second phone number is a number that corresponds to user 102. The one or more websites are present on Internet form 104, which is maintained by lead generator 106. Thereafter, at step 406, at least one of the sales agents, such as sales agent 114, is selected by lead generator 106, based on the bid price method. The bid price method is discussed in detail in FIG. 6. Subsequently, the selected sales agent is connected with user 102 by lead generator 106 at step 408.

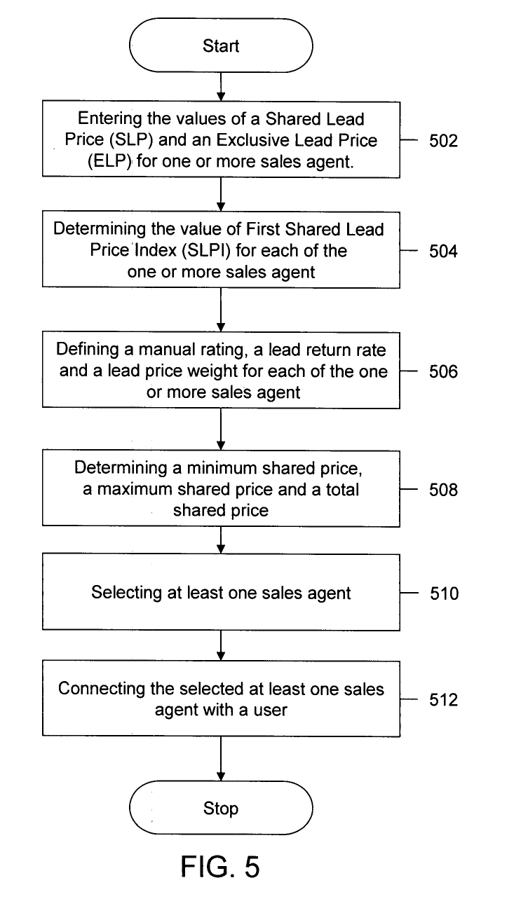

FIG. 5 is a flowchart for connecting user 102 with sales agent 114, in accordance with another embodiment of the present invention. At step 502, the exclusive lead price (ELP), the shared lead price (SLP) and the first phone number, which correspond to each of the one or more sales agents, are entered in lead generator 106. At step 504, the first shared lead price index (SLPI) for each of the one or more sales agents is determined. The determination of the first SLPI is explained in detail in conjunction with FIG. 7. At step 506, the manual rating, lead return rate and lead price weight are defined for each of the one or more sales agents. The manual rating is assigned to each of the sales agents, based on a request made by the sales agents for a lower or higher percentage of lead flow. In an embodiment of the present invention, a manual rating of 0.8 is assigned to each of the sales agents by default. In another embodiment of the present invention, the manual rating can be changed to 1 that corresponds to a sales agent who makes a request for a high percentage of lead flow. In yet another embodiment of the present invention, the manual rating of a sales agent who makes a request for low percentage of lead flow can be set to 0. In various embodiments of the invention, the lead price weight is equal to ten. However, in other embodiments the lead price weight may be change to other values

The lead return rate is the ratio between the lead flow that has been returned, or has been unsuccessful, and the total number of lead flows received that corresponds to each of the sales agents. Mathematically, it can be defined by the equation 1:

Lead return rate=(number of unsuccessful leads)/(total number of lead flow) (1)

At step 508, the minimum, maximum and total shared price is determined for each of the sales agents. The minimum shared price is the minimum value of the shared lead price corresponding to the sales agents. The maximum shared price is the maximum value of the shared lead price corresponding to the one or more sales agents. The total shared lead price is the sum of all the shared lead prices corresponding to the sales agents. Thereafter, at step 510, at least one of the one or more sales agents is selected, based on the bid price method. At step 512, the selected sales agent is connected to user 102.

FIG.6 is a flowchart illustrating the bid price method for selecting at least one of the one or more sales agents who can be connected to user 102, in accordance with an embodiment of the present invention. At step 602, the first set of one or more sales agents is selected from the one or more sales agents. The selection of the first set of sales agents is based on the shared lead price of each of the one or more sales agents. The first set of sales agents includes the sales agents with highest shared lead price among the one or more sales agents.

Thereafter, at step 604, lead generator 106 calculates the second shared lead price index, the exclusive lead price index and the broker rating index corresponding to each of the first set of sales agents. The second shared lead price index is based on the first shared lead price index and the lead price weight and is defined by the equation 2:

Second shared lead price index=(first shared lead price index)*(lead price weight) (2)

The exclusive lead price index is based on the exclusive lead price and the lead price weight and is defined by the equation 3:

Exclusive lead price index=(exclusive lead price)*(lead price weight) (3)

The broker rating index is based on the manual rating and the lead return rate and is defined by the equation 4:

Broker rating index=(manual rating)*(10)*(1−(lead return rate)/100) (4)

At step 606, the shared lead value index and the exclusive lead value index corresponding to each of the first set of sales agents are calculated. The shared lead value index (SLVI) is based on the second shared lead price index and the broker rating index and is defined by the equation 5:

Shared lead value index=(second shared lead price index)+(broker rating index) (5)

The exclusive lead value index (ELVI) is based on the exclusive lead price and the broker rating index and is defined by the equation 6:

Exclusive lead value index=(exclusive lead price index)+(broker rating index) (6)

In accordance with an embodiment of the present invention, the second shared lead price index, the exclusive lead price index, the broker rating index, the SLVI, and the ELVI corresponding to all the sales agents are calculated by lead generator 106.

Subsequently, at step 608, the highest ELVI and the highest value of SLVI are selected from the first set of sales agents. The highest ELVI and highest SLVI selected are compared at step 610. In an embodiment of the present invention, if the highest ELVI is higher than the highest SLVI, one sales agent from the first set of sales agents with the highest ELVI is selected at step 612.

In accordance with an embodiment of the present invention, if there is a single sales agent with the highest exclusive lead value index, the lead is directed to that sales agent.

In accordance with another embodiment of the present invention, if there is a plurality of sales agents with the highest exclusive lead value index, the lead is directed randomly to one of the plurality of sales agents with the highest exclusive lead value index.

However, in another embodiment of the present invention, if the highest exclusive lead value index is less than the highest shared lead value index, the lead is directed to the second set of sales agents, who are selected from the first set of the sales agents, as shown at step 614. The sales agent among the second set of sales agents who responds to the call first is connected to user 102.

In accordance with an embodiment of the invention, the second set of sales agents includes a set of sales agents from the first set of sales agents who have been selected on the basis of a pre-defined threshold lead return rate. The pre-defined threshold lead return rate, which corresponds to the lowest and highest lead return rate, is entered in database 202.

In accordance with an embodiment of the invention, the second set of sales agents is equal to the first set of sales agents when each of the sales agents of the first set of sales agents has a lead return rate that is below the pre-defined threshold lead return rate.

In accordance with an exemplary embodiment of the present invention, lead generator 106 includes the records of three sales agents with the sales agent ID of 732, 738 and 731. Table 1 shows the shared lead price, the exclusive lead price, the manual rating, the lead return and the lead price weight that corresponds to each of the three sales agents. The first shared lead price that corresponds to each of the three sales agents is determined. Similarly, the minimum, maximum and total shared price is determined corresponds to the three sales agents.

TABLE 1

| | | | | |
|---|---|---|---|---|
| Enter Values | Enter broker ID | 732 | 738 | 731 |
| | Shared lead price | 2 | 0 | 2 |
| | Exclusive lead price | 5 | 0 | 4 |
| | First shared lead price index | 4 | 0 | 4 |
| | Manual rating | 0 | 1 | 0.8 |
| | Lead return rate | 94.57 | 0 | 1.63 |
| | Lead price weight | 10 | 10 | 10 |
| | Manual | | | |
| | Min shared price | 0 | | |
| | Max shared price | 2 | | |
| | Total shared price | 4 | | |

TABLE 2

| | | | | |
|---|---|---|---|---|
| Calculated | Second shared lead price index = (shared | 40 | 0 | 40 |
| Formulae | lead price index) * (lead price weight) | | | |
| | Exclusive lead price index = (exclusive lead | 50 | 0 | 40 |
| | price) * (lead price weight) | | | |
| | Broker rating index = (manual rating) * 10 * | 0 | 10 | 7.87 |
| | (1 − (lead return rate)/100) | | | |
| | Shared lead value index = (shared lead price | 40 | 10 | 47.87 |
| | index) + (broker rating index) | | | |
| | Exclusive lead value index = (exclusive lead | 50 | 10 | 47.87 |
| | price index) + (broker rating index) | | | |

As shown in Table 2, the second shared lead price index, the exclusive lead price index, the broker rating index, the shared lead value index and the exclusive lead value index are calculated correspond to each of the three sales agents. The highest exclusive lead value index is more than the highest shared lead value index. Therefore, the lead is directed to the sales agent with the ID 732, who has the highest exclusive lead value index.

In accordance with another exemplary embodiment of the present invention, lead generator 106 includes the records of two sales agents with sales agent IDs of 790 and 798, respectively. Table 3 shows the shared lead price, the exclusive lead price, the manual rating, the lead return and the lead price weight which correspond to each of the two sales agents. The first shared lead price is determined and corresponds to each of the two sales agents. The minimum shared price, the maximum shared price and the total shared price is determined corresponding to the two sales agents.

TABLE 3

| | | | |
|---|---|---|---|
| Enter Values | ID of sales agent | 790 | 798 |
| | Shared lead price | 5 | 10 |
| | Exclusive lead price | 17 | 17 |
| | First shared lead price index | 22 | 27 |
| | Manual rating | 0 | 0 |
| | Lead return rate | 0 | 0 |
| | Manual | | |
| | Min shared price | 5 | |
| | Max shared price | 10 | |
| | Total shared price | 15 | |

TABLE 4

| | | | |
|---|---|---|---|
| Calculated | Shared lead price index = (shared lead | 220 | 270 |
| Formulae | price index) * (lead price weight) | | |
| | Exclusive lead price index = (exclusive | 170 | 170 |
| | lead price) * (lead price weight) | | |
| | Broker rating index = (manual rating) * 10 * | 0 | 0 |
| | (1 − (lead return rate)/100) | | |
| | Shared lead value index = (shared lead | 220 | 270 |
| | price index) + (broker rating index) | | |
| | Excl lead value index = (exclusive lead | 170 | 170 |
| | price index) + (broker rating index) | | |

As shown in Table 4, the second shared lead price index, the exclusive lead price index, the broker rating index, the shared lead value index and the exclusive lead value index are calculated for both the sales agents. The highest shared lead value index is greater than the highest exclusive lead value index; therefore, the lead is shared among the sales agents with the IDs 790 and 798.

In accordance with yet another exemplary embodiment of the present invention, the lead generator includes the records of five sales agents with the sales agent IDs 792, 794, 788, 796 and 786, respectively. Table 5 shows the shared lead price, the exclusive lead price, the manual rating, the lead return and the lead price weight which correspond to each of the five sales agents that corresponds to the five sales agents. A set of four sales agents with the IDs 792, 794, 788 and 796 is chosen, based on the shared lead price. The minimum, maximum and total shared price is determined and corresponds to the set of four sales agents.

TABLE 5

| | | | | | | |
|---|---|---|---|---|---|---|
| Enter Values | Enter broker ID | 792 | 794 | 788 | 796 | 786 |
| | Shared lead price | 10 | 7 | 18 | 7 | 3 |
| | Exclusive lead price | 12 | 25 | 21 | 19 | 38 |
| | Shared lead price | 42 | 42 | 42 | 42 | 38 |
| | index | | | | | |
| | Manual rating | 0.8 | 0.8 | 0.8 | 0.8 | 0.8 |
| | Lead return rate app | 12 | 3 | 8 | 93 | 38 |
| | Manual | | | | | |
| | Min shared price | 7 | | | | |
| | Max shared price | 18 | | | | |
| | Total shared price | 42 | | | | |

TABLE 6

| | | | | | | |
|---|---|---|---|---|---|---|
| Calculated | Shared lead price index = (shared | 420 | 420 | 420 | 420 | 380 |
| Formulae | lead price index) * (lead price weight) | | | | | |
| | Exclusive lead price index = (excl | 120 | 250 | 210 | 190 | 380 |
| | lead price) * (lead price weight) | | | | | |
| | Broker rating index = (manual | 70.4 | 77.6 | 73.6 | 5.6 | 49.6 |
| | rating) * (100) * (1 − (lead return | | | | | |
| | rate)/100) | | | | | |
| | Shared lead value index = (shared | 490.4 | 497.6 | 493.6 | 425.6 | 429.6 |
| | lead price index) + (broker rating | | | | | |
| | index) | | | | | |
| | Excl lead value index = (excl lead | 190.4 | 327.6 | 283.6 | 195.6 | 429.6 |
| | price index) + (broker rating index) | | | | | |

As shown in Table 6, the second shared lead price index, the exclusive lead price index, the broker rating index, the shared lead value index and the exclusive lead value index are calculated corresponding to each of the five sales agents. The highest shared lead value index is greater than the highest exclusive lead value index; therefore, the lead is shared among the set of four sales agents with the IDs 792, 794, 788 and 796.

FIG. 7 is a flowchart for the calculation of the first shared lead price index, in accordance with an embodiment of the present invention. At step 702, the value of the shared lead price is checked. If the value of the shared lead price is 0, the first shared lead price index is set to 0, as shown in step 704. However, if the shared lead price is not equal to 0, another check is performed at step 706 to check the value of the shared lead price. In an embodiment of the present invention, if the shared lead price is higher than or equal to the minimum shared price, and the shared lead price is less than or equal to the maximum shared price, the shared lead price index is equal to the total shared price, as shown in step 708. In another embodiment of the present invention, if the shared lead price is less than the minimum shared price, or the shared lead price is greater than the maximum shared price, the first shared lead price index is equal to the minimum shared price subtracted from the sum of the total shared price and the shared lead price, as shown in step 710, and is defined by equation 7:

First shared lead price index=(total shared price)−(minimum shared price)+(shared lead price) (7)

In accordance with various embodiments of the invention, the registration of the one or more sales agents includes maintaining the current status of the one or more sales agents. These one or more sales agents may select their status as ‘active’, ‘suspended’, ‘capped’ or ‘cancelled’. The sales agents of the one or more sales agents with the ‘active’ status are considered for the bid price algorithm, while those with the ‘cancelled’ status are not considered for the bid price algorithm. Further, the one or more sales agents may choose not to be considered for the bid price algorithm temporarily by opting for a ‘suspended’ status. Moreover, the one or more sales agents may have a ‘capped’ status if they choose to be considered for a fixed number of leads. For example, a sales agent who wants to receive a lead during a particular time of the day may choose to have a ‘suspended’ status for the remaining portion of the day. A sales agent who wants to receive a fixed number of leads during the day may choose to have a ‘capped’ status after receiving the fixed number of leads during the day.

In accordance with an embodiment of the invention, the lead may be assigned to one or more sales agents through a referral system or an Interactive Voice Response (IVR) system.

The present invention described above has a number of advantages. The method and system provide the functionality of establishing a connection between the user and the sales agent based on the services-of-interest of the user. This helps in reducing the number of false calls that a sales agent and a user have to go through using the existing systems. Further, as the system connects the user with the sales agent based on the services-of-interest, the chances of successful conversion of a lead also increases. Furthermore, the method is automated and does not require manual intervention to establish the connection. The invention also provides a simplified billing system for sales agents.

The present invention can be implemented in a variety of computer languages such as Java, C, C++, Perl, Python, LISP, BASIC, assembly, etc. The implementation of the present invention does not require any specific platform. Any platform that can provide means of support for simple arrays and associative arrays may be used. A few examples of such platforms are Windows™, Linux and Unix™.

The computer program product of the invention is executable on a computer system for causing the computer system to perform a method of video encoding including a motion estimation method of the present invention. The computer system includes a microprocessor, an input device, a display unit and an interface to the Internet. The microprocessor is connected to a communication bus. The computer also includes a memory. The memory may include Random Access Memory (RAM) and Read Only Memory (ROM). The computer system further comprises a storage device. The storage device can be a hard disk drive or a removable storage drive such as a floppy disk drive, optical disk drive, etc. The storage device can also be other similar means for loading computer programs or other instructions into the computer system. The computer system also includes a communication unit. The communication unit allows the computer to connect to other databases and the Internet through an I/O interface. The communication unit allows the transfer as well as reception of data from other databases. The communication unit may include a modem, an Ethernet card, or any similar device which enables the computer system to connect to databases and networks such as LAN, MAN, WAN and the Internet. The computer system facilitates inputs from a user through input device, accessible to the system through I/O interface.

The computer system executes a set of instructions that are stored in one or more storage elements, in order to process input data. The set of instructions may be a program instruction means. The storage elements may also hold data or other information as desired. The storage element may be in the form of an information source or a physical memory element present in the processing machine.

The set of instructions may include various commands that instruct the processing machine to perform specific tasks such as the steps that constitute the method of the present invention. The set of instructions may be in the form of a software program. Further, the software may be in the form of a collection of separate programs, a program module with a larger program or a portion of a program module, as in the present invention. The software may also include modular programming in the form of object-oriented programming. The processing of input data by the processing machine may be in response to user commands, results of previous processing or a request made by another processing machine.

While the preferred embodiments of the invention have been illustrated and described, it will be clear that the invention is not limited to these embodiments only. Numerous modifications, changes, variations, substitutions and equivalents will be apparent to those skilled in the art, without departing from the spirit and scope of the invention, as described in the claims.

What is claimed is:

1. A method for establishing a connection between a user and a sales agent, wherein the connection being established by a lead generator, the lead generator comprising a database of one or more sales agents, the method comprising:
a. registering the one or more sales agents with the lead generator, the registration of each of the one or more sales agents comprises providing a first phone number, an exclusive lead price and a shared lead price;
b. entering a second phone number by the user on an internet form, the internet form being present on one or more websites, the internet form being connected to the lead generator;
c. selecting at least one of the one or more sales agents by the lead generator, the selection of the at least one sales agent being based on an exclusive lead value index and a shared lead value index, the exclusive lead value index being based on the exclusive lead price, and the shared lead value index being based on the shared lead price; and
d. connecting the selected at least one sales agent with the user by the lead generator, the connection being established between the first phone number and the second phone number.

2. The method according to claim 1, wherein the registration of the one or more sales agents further comprising:
a. providing a lead return rate corresponding to each of the one or more sales agents, the lead return rate being based on number of successful conversions of a lead corresponding to each of the one or more sales agents;
b. providing a manual rating corresponding to each of the one or more sales agents; and
c. providing a lead price weight corresponding to each of the one or more sales agents.

3. The method according to claim 1, wherein the registration of the one or more sales agents comprises determining a first shared lead price index, the first shared lead price index being based on the shared lead price.

4. The method according to claim 1, wherein the registration of the one or more sales agents comprises maintaining a current status of the one or more sales agents, wherein a lead is directed to the one or more sales agents based on the current status of the one or more sales agents.

5. The method according to claim 1, wherein the selection of the at least one sales agent being based on calculation of a second shared lead price index, wherein the calculation of the second shared lead price index being based on a first shared lead price index and a lead price weight.

6. The method according to claim 1, wherein the selection of the at least one sales agent being based on calculation of an exclusive lead price index, wherein the calculation of the exclusive lead price index being based on the exclusive lead price and a lead price weight.

7. The method according to claim 1, wherein the selection of the at least one sales agent being based on calculation of a broker rating index, wherein the calculation of the broker rating index being based on a manual rating and a lead return rate.

8. The method according to claim 1, wherein the exclusive lead value index and the shared lead value index being further based on a broker rating index.

9. The method according to claim 1, wherein the selection of the at least one sales agent being based on at least one of geographical location of the user, one or more services-of-interest of the user and current status of the one or more sales agents.

10. The method according to claim 1, wherein the connection of the selected at least one sales agent comprises making a call to a single sales agent, the single sales agent being called when a highest value of the exclusive lead value index is greater than a highest value of the shared lead value index.

11. The method according to claim 1, wherein the connection of the selected at least one sales agent comprises making a call to a plurality of sales agents, the plurality of sales agents being called when the highest value of the shared lead value index is greater than the highest value of the exclusive lead value index.

12. The method according to claim 1, wherein the connection of the selected at least one So sales agent further comprises sending an introductory message to the selected at least one sales agent, the introductory message comprising information of the user.

13. The method according to claim 12, wherein the introductory message is a voice-transcription-information based on the one or more services-of-interest of the user and comprises at least one of information on demographic profile of the user or a sponsored message from a product provider, the product provider providing the introductory message based on the one or more services-of-interest of the user.

14. The method according to claim 1 further comprising billing of the selected at least one sales agent, wherein the billing is based on at least one of the length of a call, a demographic profile of the user, a geographic location of the user, one or more services-of-interest of the user or frequency and volume of usage of the lead generator by the selected at least one sales agent.

15. A method for selecting at least one of one or more sales agents for assigning a lead, wherein the lead being assigned by a lead generator, the lead generator comprising a database of the one or more sales agents, the database comprising an exclusive lead price and a shared lead price corresponding to each of the one or more sales agents, the method comprising:
a. selecting a first set of the one or more sales agents based on the shared lead price;
b. calculating a shared lead value index and an exclusive lead value index by the lead generator corresponding to each of the first set of the one or more sales agents, wherein the shared lead value index being based on the shared lead price and the exclusive lead value index being based on the exclusive lead price;
c. selecting a highest exclusive lead value index and a highest shared lead value index from the shared lead value indices and the exclusive lead value indices calculated for the first set of the one or more sales agents;
d. comparing the highest exclusive lead value index and the highest shared lead value index;
e. selecting one sales agent from the first set of the one or more sales agents for assigning the lead, the selected one sales agent having the highest exclusive lead value index, wherein the lead is assigned to the one sales agent when the highest exclusive lead value index is greater than the highest shared lead value index; and
f. selecting a second set of the one or more sales agents from the first set of the one or more sales agents for assigning the lead when the highest exclusive lead value index is less than the highest shared lead value index.

16. The method according to claim 15 further comprises calculating a first shared lead price index, the first shared lead price index being based on the shared lead price.

17. The method according to claim 15 further comprises calculating a second shared lead price index, wherein the calculation of the second shared lead price index being based on the shared lead price and a lead price weight corresponding to each of the one or more sales agents.

18. The method according to claim 15 further comprises calculating an exclusive lead price index, wherein the calculation of the exclusive lead price index being based on the exclusive lead price and a lead price weight corresponding to each of the one or more sales agents.

19. The method according to claim 15 further comprises calculating a broker rating index, wherein the calculation of the broker rating index being based on a manual rating assigned to each of the one or more sales agents and a lead return rate, the lead return being based on successful conversion of a lead corresponding to each of the one or more sales agents.

20. The method according to claim 19, wherein the exclusive lead value index and the shared lead value index is further based on the broker rating index.

21. A system for establishing a connection between a user and a sales agent, wherein the connection being established between a first phone number and a second phone number, the system comprising:
a. a lead generating module, the lead generating module establishing a connection between the user and the sales agent, the lead generating module comprising:
i. a database, the database including a record corresponding to one or more sales agents; the one or more sales agents registering with the database, the registration of the one or more sales agents comprising providing a first phone number, an exclusive lead price and a shared lead price corresponding to each of the one or more sales agents;
ii. a selecting module, the selecting module selecting at least one of the one or more sales agents, the selection of the at least one of the one or more sales agents being based on an exclusive lead value index and a shared lead value index, the exclusive lead value index being based on the exclusive lead price, and the shared lead value index being based on the shared lead price;
b. a connecting module, the connecting module connecting the selected at least one sales agent with the user, wherein the connection being established between the first phone number corresponding to the selected at least one sales agent and the second phone number corresponding to the user.

22. The system according to claim 21 further comprising a message generating module, wherein the message generating module sends an introductory message to the selected at least one sales agent.

23. The system according to claim 21 further comprising a billing module, wherein the billing module performs billing of the selected at least one sales agent.

24. The system according to claim 21, wherein the database further includes:
a. a lead return rate, the lead return being based on successful conversion of a lead corresponding to each of the one or more sales agents;
b. a manual rating assigned corresponding to each of the one or more sales agents;
c. a lead price weight corresponding to each of the one or more sales agents; and
d. a first shared lead price index, wherein the first shared lead price index is based on the shared lead price.

25. A selecting module for selecting at least one of one or more sales agents for assigning a lead, the lead being assigned based on an exclusive lead price and a shared lead price, the selecting module comprising:
a. a first selecting module, the first selecting module selecting a first set of the one or more sales agents from the one or more sales agent, the selection being based on the shared lead price;
b. a calculating module, the calculating module calculating a shared lead value index and an exclusive lead value index corresponding to each sales agent of the first set of the one or more sales agents, wherein the shared lead value index being based on the shared lead price, and the exclusive lead value index being based on the exclusive lead price;
c. a second selecting module, the second selecting module selecting a highest exclusive lead value index and a highest shared lead value index from the shared lead value indices and the exclusive lead value indices calculated for the first set of the one or more sales agents;
d. a comparator, the comparator comparing the highest exclusive lead value index and the highest shared lead value index; and
e. a third selecting module, the third selecting module selecting a second set of sales agents from the first set of the one or more sales agents when the highest exclusive lead value index is less than the highest shared lead value index, the third selecting module selecting one sales agent of the first set of the one or more sales agents when the highest exclusive lead value index is greater than the highest shared lead value index.
